(19) United States
(12) Patent Application Publication
(10) Pub. No.: US 2009/0207498 A1
(43) Pub. Date: Aug. 20, 2009

(54) DEVICE AND METHODS FOR MAGNIFYING TEXT

(76) Inventor: Christy L Hauge, Port St. Lucie, FL (US)

Correspondence Address: NW-IP-LAW, 6039 E. Grant RD., Tucson, AZ, 85712, US

(21) Appl. No.: 12/034,557

(22) Filed: Feb. 20, 2008

(51) Int. Cl. G02B 25/00; G02B 1/04

(52) U.S. Cl. 359/642

(57) ABSTRACT

The present invention features a magnifying sheet for magnifying the text on a medicine bottle or a display panel of an electronic device. The magnifying sheet comprises a front side and a back side, wherein the front side comprises a magnifying component, wherein the back side comprises a non-permanent adhesive. The present invention also features a method of enhancing the legibility of text on a medicine bottle or a display panel of an electronic device. The method comprises affixing a magnifying sheet to a medicine bottle or an electronic device, wherein the magnifying sheet comprises a front side and a back side. The front side of the magnifying sheet comprises a magnifying component, and the back side comprises a non-permanent adhesive.

### FIELD OF THE INVENTION

The present invention is directed to methods of improving legibility of text and labels using magnification devices such as attachable magnifiers which match the contour of the object needing magnification.

### BACKGROUND OF THE INVENTION

Millions of people take prescriptions and over-the-counter medications every day to improve or maintain their health. Many medications are packaged in relatively small containers such as small plastic or glass bottles. The text on the medication bottle label, which usually contains information such as the prescription name, recommended dosage, contraindications, pharmacy and/or physician phone numbers, and prescription identification number, is often very small. The small or fine print may be difficult for individuals, particularly those poor eyesight, and difficult to read. Products have previously been made to address this problem. The disclosure of the patents U.S. Pat. No. 6,621,629 B2, U.S. Pat. Nos. 5,309,279, 5,193,032, 5,204,775, 6,549,345 B1 are incorporated in their entirety herein by reference. For example, the U.S. Pat. No. 6,621,629 B2 describes a cylindrical magnifying lens having ends that roll up on each other. The U.S. Pat No. 5,204,775 describes a magnifying lens that can be attached to medicine bottles using hook-and-loop fasteners and also describes a magnifying lens comprising a magnifying window that can be attached to medicine bottles. However, these magnifiers are not very compact, do not adhere well to the medicine bottle, and may distort the text on the medicine bottle label. Additionally, text on electronic devices such as mobile telephones and digital music players (e.g., MP3 players), is often very small and difficult to read.

The present invention features a magnifying sheet for magnifying the text on a medicine bottle or a display panel of an electronic device. The magnifying sheet comprises a front side and a back side, wherein the front side comprises a magnifying component, wherein the back side comprises a non-permanent adhesive. The present invention also features a method of enhancing the legibility of text on a medicine bottle or a display panel of an electronic device. The method comprises affixing a magnifying sheet to a medicine bottle or an electronic device, wherein the magnifying sheet comprises a front side and a back side. The front side of the magnifying sheet comprises a magnifying component, and the back side comprises a non-permanent adhesive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

### BRIEF DESCRIPTION OF THE DRAWINGS

FIG. 1 is a perspective view of the present invention illustrating the magnifying sheet 100 affixed to a medicine bottle label 200 of a medicine bottle 300, magnifying the medicine bottle label text 210.

FIG. 2 is a perspective view of the magnifying sheet 100 illustrating the front side 110 and the back side 120.

FIG. 3 is a cross-sectional view of the magnifying sheet 100 showing the front side 110 and back side 120.

FIG. 4 is a perspective view of the magnifying sheet 100 being affixed to the display panel 410 of a mobile telephone 400.

FIG. 5 is a perspective view of the magnifying sheet 100 affixed to the display panel 410 of a mobile telephone 400.

### DESCRIPTION OF PREFERRED EMBODIMENTS

The following is a listing of numbers corresponding to a particular element refer to herein:
100 magnifying sheet
110 front side
120 back side
200 medicine bottle label
210 medicine bottle label text
300 medicine bottle
400 mobile telephone
410 display panel

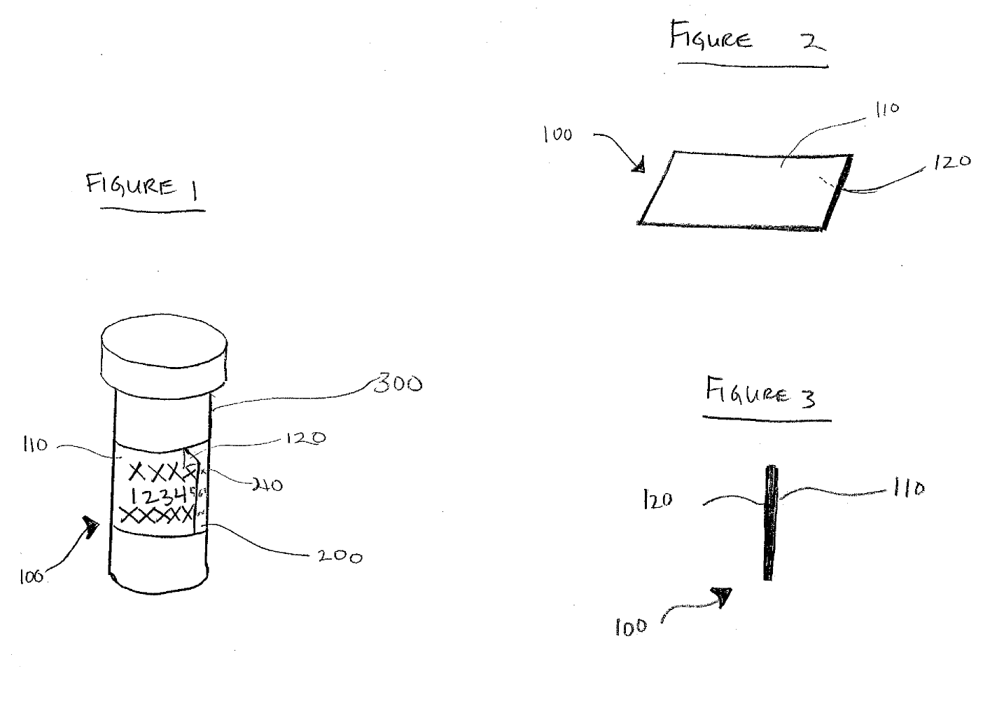

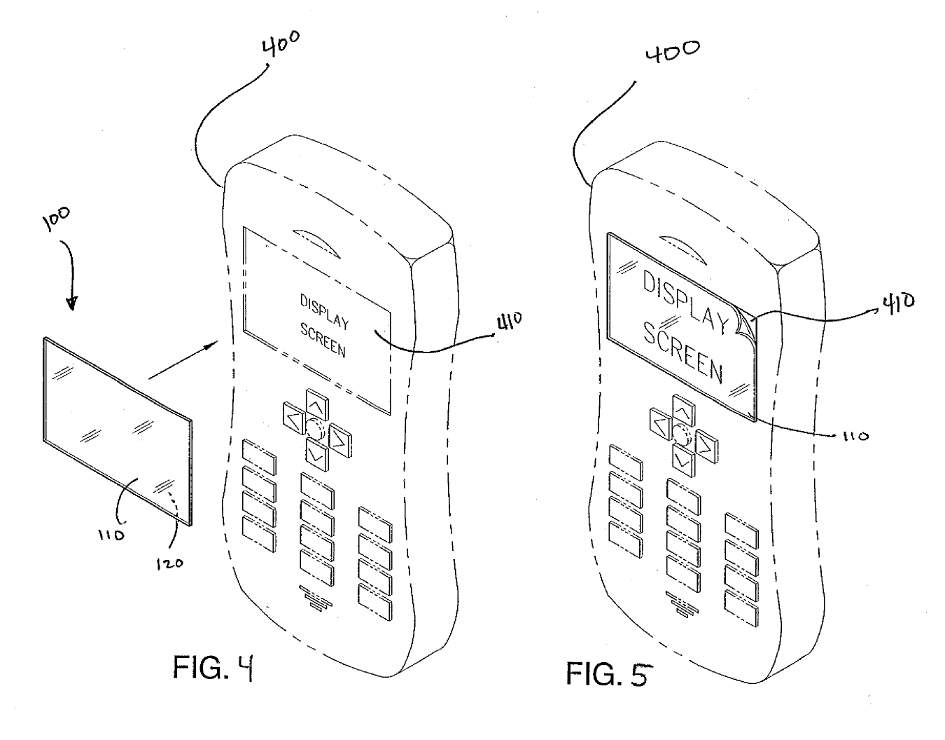

Referring now to FIGS. 1 through 5, the present invention features a magnifying sheet 100 comprising a front side 110 and a back side 120, wherein the front side 110 comprises a magnifying component, wherein the back side 120 comprises a non-permanent adhesive. The magnifying sheet 100 is for magnifying a medicine bottle label text 210 or a display panel of an electronic device 410.

The present invention also features a method of enhancing the legibility of a medicine bottle label text 210 on a medicine bottle 300. The method comprises affixing a magnifying sheet 100 to a medicine bottle label 200, wherein the magnifying sheet comprises a front side 110 and a back side 120, wherein the front side 110 comprises a magnifying component, wherein the back side 120 a non-permanent adhesive, wherein the magnifying sheet 100 magnifies the medicine bottle label text 210.

The present invention also features a method of enhancing the legibility of a display panel 410 of an electronic device. The method comprises affixing a magnifying sheet 100 to a display panel 410 of an electronic device (e.g., a mobile telephone 400), wherein the magnifying sheet 100 comprises a front side 110 and a back side 120, wherein the front side 110 comprises a magnifying component, wherein the back side 120 a non-permanent adhesive, wherein the magnifying sheet 100 magnifies the display panel 410 of the electronic device.

As used herein, the term “legibility” refers to the ability of a reader to see and/or read the characters and/or symbols. Without wishing to limit the present invention to any theory or mechanism, it is believed that the present invention is advantageous over the prior art because it is more compact, more uniform, will not distort the text on the medicine bottle label, and will adhere better to the medicine bottle label. Also, it is believed that the present invention is reusable, transferrable from one medicine bottle to another, transferrable from one electronic device to another, and disposable.

As used herein, the term “about” refers to plus or minus ten percent (10%) of the referenced value. For example, an embodiment wherein a magnifying sheet 100 is about 1 millimeter thick as measured from the front side 110 to the back side 120 includes a magnifying sheet 100 that is between 0.9 millimeters and 1.1 millimeters thick as measured from the front side 110 to the back side 120.

The magnifying sheet 100 may be constructed from a variety of materials that are capable of magnifying text. (See, for example, U.S. Pat. No. 6,621,629 and No. 6,275,333, the disclosures of which are incorporate in their entirety herein by reference). These materials would be known to one of ordinary skill in the art. For example, in some embodiments, the magnifying sheet 100 comprises a plastic, a polyurethane, a vinyl, a polyvinyl chloride, polyethylene terephthalate or a combination thereof.

In some embodiments, the non-permanent adhesive comprises a copolymer microsphere. Copolymer microspheres would be well known to one of ordinary skill in the art. Examples of copolymer microspheres include the inventions disclosed in U.S. Pat. No. 3,691,140 and U.S. Pat. No. 5,280,061, the disclosures of which are incorporated in their entirety herein by reference. In some embodiments, the non-permanent adhesive comprises an acrylate copolymer microsphere, a methacrylate, a temporary glue, or a combination thereof.

In some embodiments, the magnifying sheet 100 is in the shape of a rectangle, a circle, an oval, a triangle, a parallelogram, or a combination thereof.

In some embodiments, the electronic device includes but is not limited to a telephone, a mobile telephone, a digital music player, a camera, a camcorder, a global positioning system device, a combination thereof and the like.

In some embodiments, the magnifying sheet 100 is temporarily affixed to the medicine bottle 300 or the electronic device. In some embodiments, the magnifying sheet 100 is removed from a medicine bottle 300 and affixed to another medicine bottle 300. In some embodiments, the magnifying sheet 100 is removed from an electronic device and affixed to another electronic device. In some embodiments, the magnifying sheet 100 may be reused at least one time. In some embodiments, the magnifying sheet 100 may be reused at least two times. In some embodiments, the magnifying sheet 100 may be reused at least three times.

The thickness of the magnifying sheet 100 refers to the distance between the front side 110 and the back side 120 of the magnifying sheet 100. The thickness of the magnifying sheet 100 may be any thickness that allows for the magnification of text on the medicine bottle label. For example, in some embodiments, the magnifying sheet 100 is about 0.1 millimeters thick. In some embodiments, the magnifying sheet 100 is about 0.5 millimeters thick. In some embodiments, the magnifying sheet 100 is about 1 millimeter thick. In some embodiments, the magnifying sheet 100 is about 2 millimeters thick. In some embodiments, the magnifying sheet 100 is about 3 millimeters thick. In some embodiments, the magnifying sheet 100 is about 4 millimeters thick. In some embodiments, the magnifying sheet 100 is between about 0.1 and 5 millimeters thick.

The magnifying sheet 100 may have a variety of magnifying power. For example, one person may wish to have his or her medicine bottle label text 210 magnified more than another person. In some embodiments, the magnifying sheet 100 magnifies the medicine bottle label text 210 about 1.5 fold. In some embodiments, the magnifying sheet 100 magnifies the medicine bottle label text 210 about 2 fold. In some embodiments, the magnifying sheet 100 magnifies the medicine bottle label text 210 about 3 fold. In some embodiments, the magnifying sheet 100 magnifies the medicine bottle label text 210 about 4 fold. In some embodiments, the magnifying sheet 100 magnifies the medicine bottle label text about 5 fold. In some embodiments, the magnifying sheet 100 magnifies the medicine bottle label text 210 between about 1.5 to 5 fold.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A magnifying sheet comprising:
(a) a front side, wherein the front side comprises a magnifying component; and
(b) a back side, wherein the back side comprises a non-permanent adhesive;
wherein the magnifying sheet magnifies text on a medicine bottle label or a display panel of an electronic device.

2. The magnifying sheet of claim 1, wherein the magnifying component comprises a plastic, a polyurethane, a vinyl, a polyvinyl chloride, or a combination thereof.

3. The magnifying sheet of claim 1, wherein the non-permanent adhesive comprises a copolymer microsphere.

4. The magnifying sheet of claim 3, wherein the copolymer microsphere comprises an acrylate.

5. The method of claim 1, wherein the magnifying sheet magnifies the text between about 1.5 fold to 5 fold.

6. The method of claim 1, wherein the magnifying sheet is in the shape of a rectangle, a circle, and oval, a triangle, a parallelogram, or a combination thereof.

7. The method of claim 1, wherein the magnifying sheet is between about 0.1 millimeters to 5 millimeters thick as measured from the front side to back side.

8. The magnifying sheet of claim 2, wherein the electronic device is a telephone, a mobile telephone, a digital music player, a camera, a camcorder, a global positioning system device, or a combination thereof.

9. The method of claim 1, wherein the magnifying sheet is temporarily affixed to a medicine bottle or an electronic device.

10. The method of claim 1, wherein the magnifying sheet is reusable.

11. A method of enhancing the legibility of text on a medicine bottle label, the method comprises affixing a magnifying sheet to the medicine bottle label, wherein the magnifying sheet comprises:
(a) a front side, wherein the front side comprises a magnifying component; and
(b) a back side, wherein the back side comprises a non-permanent adhesive;
wherein the magnifying sheet magnifies the text on the medicine bottle label.

12. The method of claim 11, wherein the transparent magnifying sheet comprises a plastic, a polyurethane, a vinyl, or a combination thereof.

13. The method of claim 11, wherein the magnifying sheet magnifies the text between about 1.5 fold to 5 fold.

14. The method of claim 11, wherein the magnifying sheet is in the shape of a rectangle, a circle, and oval, a triangle, a parallelogram, or a combination thereof.

15. The method of claim 11, wherein the magnifying sheet is between about 0.1 millimeters to 5 millimeters thick as measured from the front side to back side.

16. A method of enhancing the legibility a display panel of an electronic device, the method comprises affixing a magnifying sheet to the display panel of the electronic device, wherein the magnifying sheet comprises:
(a) a front side, wherein the front side comprises a magnifying component; and
(b) a back side, wherein the back side comprises a non-permanent adhesive;
wherein the magnifying sheet magnifies the display panel of the electronic device,

17. The method of claim 16, wherein the transparent magnifying sheet comprises a plastic, a polyurethane, a vinyl, or a combination thereof.

18. The method of claim 16, wherein the magnifying sheet magnifies the text between about 1.5 fold to 5 fold.

19. The method of claim 16, wherein the magnifying sheet is in the shape of a rectangle, a circle, and oval, a triangle, a parallelogram, or a combination thereof.

20. The method of claim 16, wherein the magnifying sheet is between about 0.1 millimeters to 5 millimeters thick as measured from the front side to back side.
